(19) United States
(12) Patent Application Publication
(10) Pub. No.: US 2003/0225856 A1
(43) Pub. Date: Dec. 4, 2003

(54) Automated methods and systems for changing a clinical study in progress

(76) Inventors: Douglas John Pietrowski, Apex, NC (US); Travis Shane Jackson, Raleigh, NC (US); Brendon Williams Ball, Raleigh, NC (US); Eric Glenn Conger, Chapel Hill, NC (US); Terrance Lee Myhrer, Cary, NC (US)

Correspondence Address: JENKINS & WILSON, PA, 3100 TOWER BLVD, SUITE 1400, DURHAM, NC, 27707, US

(21) Appl. No.: 10/160,838

(22) Filed: May 31, 2002

(51) Int. Cl. G06F 15/16

(52) U.S. Cl. 709/217

(57) ABSTRACT

Methods and systems for automatically changing a clinical study in progress are disclosed. A data collection server receives patient diary data from patient diary software executing on remotely located study participant computers and stores the patient diary data in a diary database. The data collection server determines whether any study changes have been defined in the patient diary database for the patient diary software executing on the study participant computer. In response to determining that a change has been defined, the data collection server downloads change data to the study participant computer. The study participant computer receives the change data and automatically alters the execution of the patient diary software based on the change data.

### TECHNICAL FIELD

The present invention relates to computer-implemented clinical trials data collection and management systems. More particularly, the present invention relates to automated methods and systems for changing software associated with a clinical trials data collection and management system.

### RELATED ART

In order to obtain approval from a regulatory body, such as the Food and Drug Administration in the United States, new drugs are required to go through rigorous efficacy and safety testing. This testing is referred to in the industry as clinical trials. One aspect of clinical trials includes testing drugs on human subjects and recording subjective data about how the subjects respond to the drugs. Such subjective data can include answers to questions such as, “How do you feel?” This subjective data collected from participants in a clinical study is referred to in the industry as patient diary data. In order to obtain regulatory approval for a drug, patient diary data, along with other objective and subjective data, must be collected and submitted with a new drug application (NDA).

Collecting and organizing data associated with clinical trials of a drug can be a difficult and time-consuming task. For example, in a conventional clinical study, questionnaires are given to study participants in hard copy format, and the participants are required to periodically complete the questionnaires to record their reaction to a new drug. During the study, the participants' answers are collected, manually entered into a database, and eventually submitted to the regulating agency along with the new drug application. This method of distributing hard copy questionnaires to participants, collecting responses from each participant, and manually entering the responses into a database is both time- and labor-intensive. Accordingly, computer-implemented clinical study data collection systems have been developed. In order to collect subjective data from study participants, these computer-implemented collection systems download questionnaires to computers accessible by study participants. The study participants complete the questionnaires and upload the responses to a central site. The central site stores the information in a database.

In order to allow study participants to record data when they are not located near a non-portable computer terminal, handheld computers have been used as a data collection tool. The handheld computers are typically pre-programmed with questionnaires at the central site and distributed to study participants. The study participants can carry the handhelds with them in their daily travels and record subjective data by completing the questionnaires, no matter where the participants are located. The handhelds are periodically returned to the data collection site so that the participants' responses can be collected and stored in a database. Alternatively, in newer data collection systems, the handhelds can connect to the central site via modems and periodically upload participants' answers to the questions.

In a system that uses multiple handheld or portable computers to collect data from clinical trials subjects, implementing a change to the study while the study is in progress can be a burdensome task. For example, a clinician may determine that a question in a clinical study questionnaire is not eliciting the proper response from the subjects. The clinician may desire to modify or replace the question. In conventional systems, each handheld computer contains an executable file that implements data collection for a clinical study. In order to modify the question or any other aspect of the software, it is necessary to modify the source code of the executable file, recompile the source code into a new executable file, and load the new executable file onto all of the handheld computers involved in the study.

The time required to alter the source code, re-compile the executable file, and load the new executable file onto all of the clinical study data collection units can greatly increase the time required to perform a clinical study. For example, loading new executable files on each of the handheld units typically requires that the handheld units be returned to the centralized data collection site, reprogrammed at the site, and then returned to the study participants. Even in systems where the executable could be downloaded from a remote location to the handheld units, such a solution requires validation of the entire executable and there is no protocol for replacing the executable on the handheld unit.

As mentioned above, time is critical in clinical studies for new drug applications. The time required to initiate a study, collect data, lock the database, and deliver the database to the regulatory agency needs to be minimized so that a complete new drug application can be submitted as early as possible. In the pharmaceutical industry, each day of delay caused by a mid-study change can cost millions of dollars due to delayed regulatory approval of a new drug. Accordingly, in light of the time criticality of clinical studies and the problems associated with conventional methods for performing mid-study changes, there exists a long-felt need for improved methods and systems for implementing changes in clinical studies in progress.

### DISCLOSURE OF THE INVENTION

The present invention includes methods and systems for automatically changing the data collection functionality of a clinical study in progress. A data collection server receives patient diary data from patient diary software executing on a plurality of remotely located study participant computers. The data collection server stores the patient diary data in a diary database. When a data upload occurs, the data collection server checks the diary database to determine whether any study changes have been defined for the patient diary software executing on the study participant computer. In response to determining that a change has been defined for the patient diary software executing on the study participant computer, the data collection server extracts change data from the diary database and downloads the change data to the patient computer. The study participant computer receives the change data and alters the execution of the patient diary software based on the change data.

In one example, the patient diary software on each patient diary computer includes a diary executor, an electronic patient diary file, and one or more dynamic link libraries. The diary executor is an executable file that executes the functions for presenting screens to the study participants, receiving data from the study participants, and delivering the data to the data collection server. The electronic patient diary file contains data used by the diary executor to populate questionnaires to be displayed to the study participants and instructs the diary executor as to how to display the data to the participants. The electronic patient diary file also contains a list of dynamic link libraries containing executable code for the diary executor. The dynamic link libraries contain code that alters the functionality of the diary executor. Thus, according to the present invention, one method for efficiently altering the functionality of the diary executor that does not require changes to the executable file is for the data collection server to download new dynamic link libraries to the study participant computer.

The dynamic link libraries may replace existing dynamic link libraries, or the dynamic link libraries may be new libraries. The diary executor checks the electronic patient diary file for the presence of new dynamic link libraries and executes the new dynamic link libraries if present. Thus, in one example, the present invention allows alteration of the functionality of software executing on study participant computers without requiring the executable code to be modified. In other examples, the present invention includes implementing changes to clinical studies in progress by modifying the electronic patient diary file and/or the study executor.

Accordingly, it is an object of the invention to provide a method for automatically and efficiently changing data collection functionality of a clinical study in progress without changing the executable file on a study participant computer.

It is another object of the invention to provide a method automatically and efficiently replacing an executable file on a study participant computer.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings, of which:

FIG. 1 is a schematic diagram of an exemplary operating environment for the methods and systems for changing a clinical study in progress according to the present invention;

FIG. 2 is a block diagram of an automated system for changing a clinical study in progress according to an embodiment of the present invention;

FIG. 3 is a flow chart illustrating an exemplary method for changing a clinical study in progress according to an embodiment of the present invention;

FIG. 4 is a flow chart illustrating exemplary steps that may be performed by diary executor software in changing a clinical study in progress according to an embodiment of the present invention;

FIGS. 5A-5C illustrate a data diagram illustrating exemplary tables associated with a mid-study change that may be stored in a diary database according to an embodiment of the present invention;

FIG. 6 illustrates computer screen shots associated with a study editor according to an embodiment of the present invention;

FIG. 7 illustrates computer screen shots of current users and error log folders associated with a study editor according to an embodiment of the present invention;

FIG. 8 illustrates computer screen shots of sync log and patient list folders associated with a study editor according to an embodiment of the present invention;

FIG. 9 illustrates computer screen shots of mid-study change log and create mid-study change folders associated with a study editor according to an embodiment of the present invention;

FIG. 10 illustrates computer screen shots of message log and create message folders associated with a study editor according to an embodiment of the present invention; and

FIG. 11 illustrates a computer screen shot of a test folder associated with a study editor according to an embodiment of the present invention.

### DETAILED DESCRIPTION OF THE INVENTION

### Exemplary Operating Environment

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

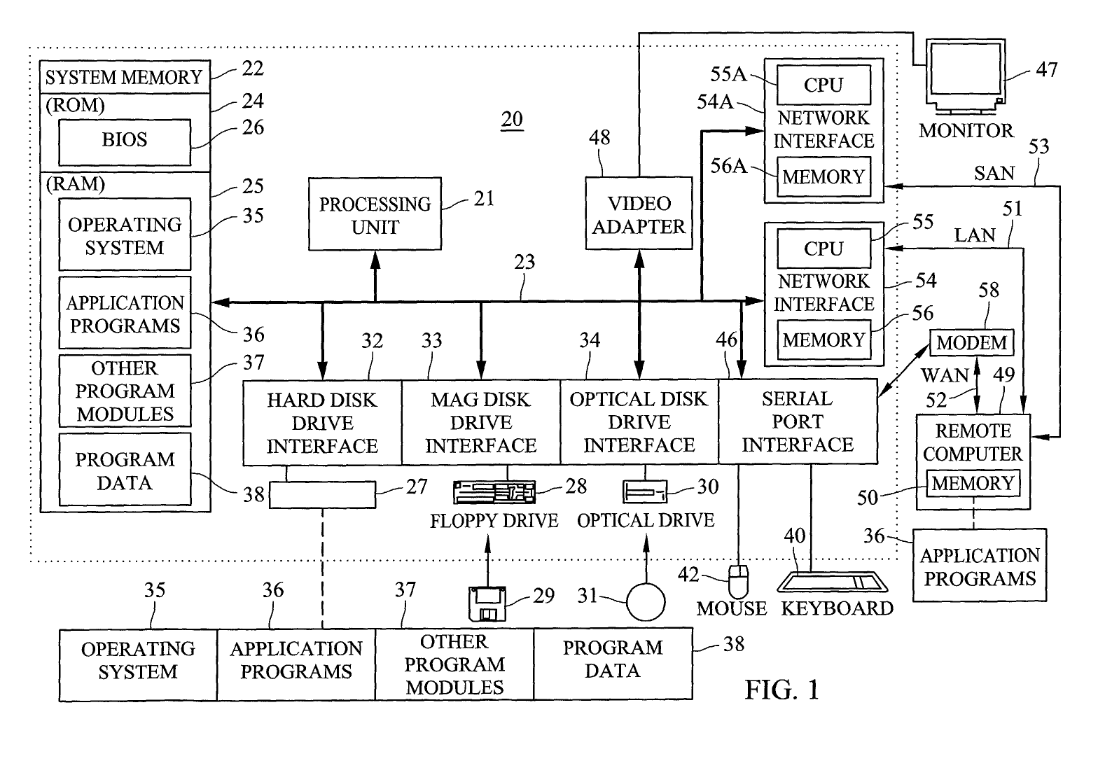

With reference to FIG. 1, an exemplary system for implementing the invention includes a general purpose computing device in the form of a conventional computer 20, including a processing unit 21, a system memory 22, and a system bus 23 that couples various system components including the system memory to processing unit 21. In a preferred embodiment of the invention, computer 20 comprises a server. System bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within computer 20, such as during start-up, is stored in ROM 24. Computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

Hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for computer 20. Although the exemplary environment described herein employs a hard disk, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38.

A user may enter commands and information into the personal computer 20 through input devices such as a keyboard 40 and a pointing device 42. Other input devices (not shown) may include a microphone, touch panel, joystick, game pad, satellite dish, scanner, or the like. These and other input devices are often connected to processing unit 21 through a serial port interface 46 that is coupled to the system bus, but may be connected by other interfaces, such as a parallel port, game port or a universal serial bus (USB). A monitor 47 or other type of display device is also connected to system bus 23 via an interface, such as a video adapter 48. In addition to the monitor, personal computers typically include other peripheral output devices, not shown, such as speakers and printers.

Computer 20 may operate in a networked environment using logical connections to one or more remote computers, such as a remote computer 49. Remote computer 49 may be a personal computer, such as a laptop computer, a hand-held computer, or a non-portable computer, and typically includes many or all of the elements described above relative to the computer 20, although only a memory storage device 50 has been illustrated in FIG. 1. The logical connections between computers 20 and 49 depicted in FIG. 1 include a local area network (LAN) 51, a wide area network (WAN) 52, and/or a system area network (SAN) 53. Local- and wide-area networking environments are commonplace in offices, enterprise-wide computer networks, intranets and the Internet.

System area networking environments are used to interconnect nodes within a distributed computing system, such as a cluster. For example, in the illustrated embodiment, computer 20 may comprise a first node in a cluster and computer 49 may comprise a second node in the cluster. In such an environment, it is preferable that computer 20 and remote computer 49 be under a common administrative domain. Thus, although computer 49 is labeled “remote,” computer 49 may be in close physical proximity to computer 20.

When used in a LAN or SAN networking environment, computer 20 is connected to local network 51 or system network 53 through network interface adapters 54 and 54A. Network interface adapters 54 and 54A may include processing units 55 and 55A and one or more memory units 56 and 56A.

When used in a WAN networking environment, computer 20 typically includes a modem 58 or other means for establishing communications over the WAN 52. Modem 58, which may be internal or external, is connected to the system bus 23 via the serial port interface 46. In a networked environment, program modules depicted relative to computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer and/or the processing units of I/O devices of electrical signals representing data in a structured form. This manipulation transforms the data or maintains it at locations in the memory system of the computer and/or the memory systems of I/O devices, which reconfigures or otherwise alters the operation of the computer and/or the I/O devices in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that the acts and operations described hereinafter may also be implemented in hardware.

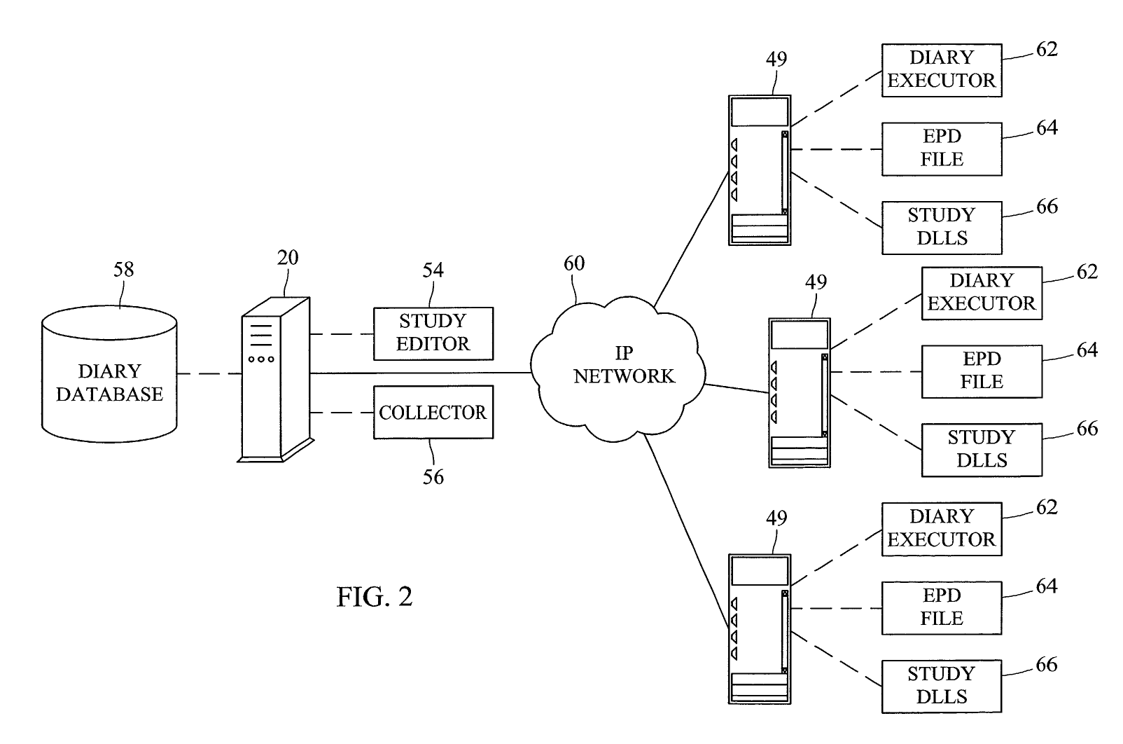

FIG. 2 illustrates a system for automatically changing a clinical study in progress according to an embodiment of the present invention. In FIG. 2, computer 20 comprises a data collection server for collecting patient diary information from a plurality of remote study participant computers 49. In a preferred embodiment, remote study participant computers 49 comprise hand-held units. Data collection server 20 includes a study editor 54, a collector 56, and a diary database 58. Study editor 54 and collector 56 comprise application programs that execute on one or more processors of data collection server 20. Study editor 54 may be an application program that allows an administrator to define study details, such as questionnaires to be given to the patients. Study editor 54 may also allow the study administrator to define study changes that change the functionality of software executing on study participant computers 49. Collector 56 may be a server application that handles connection requests from study participant computers 49 via IP network 60, receives patient diary data from study participant computers 49, and stores the diary data in diary database 58. When collector 56 accesses diary database 58 to store diary data for a particular study participant computer 49, collector 56 determines whether any study changes have been defined for the particular study participant computer. If study changes have been defined, collector 56 extracts the change data from diary database 58 and downloads the data to the patient computer.

Each study participant computer 49 includes a diary executor 62, an electronic patient diary file 64, and one or more study DLLs 66. Diary executor 62 is an executable file that controls the overall presentation of surveys to the patient, collection of survey data from the patient, and communication with collector 56. Electronic patient diary (EPD) file 64 stores the data used to populate survey forms and also stores the location of study DLLs 66 to be executed as part of a clinical study. Study DLLs 66 are libraries that alter the functionality of diary executor 62. Diary executor 62 determines which DLLs to link to at run time, rather than at compile time. Thus, adding new study DLLs or replacing study DLLs 66 can change the function of diary executor 62 without requiring rewriting and recompiling diary executor 62. This ability to easily implement a change in a study without modifying diary executor 62 decreases the time required to perform change to a study in progress.

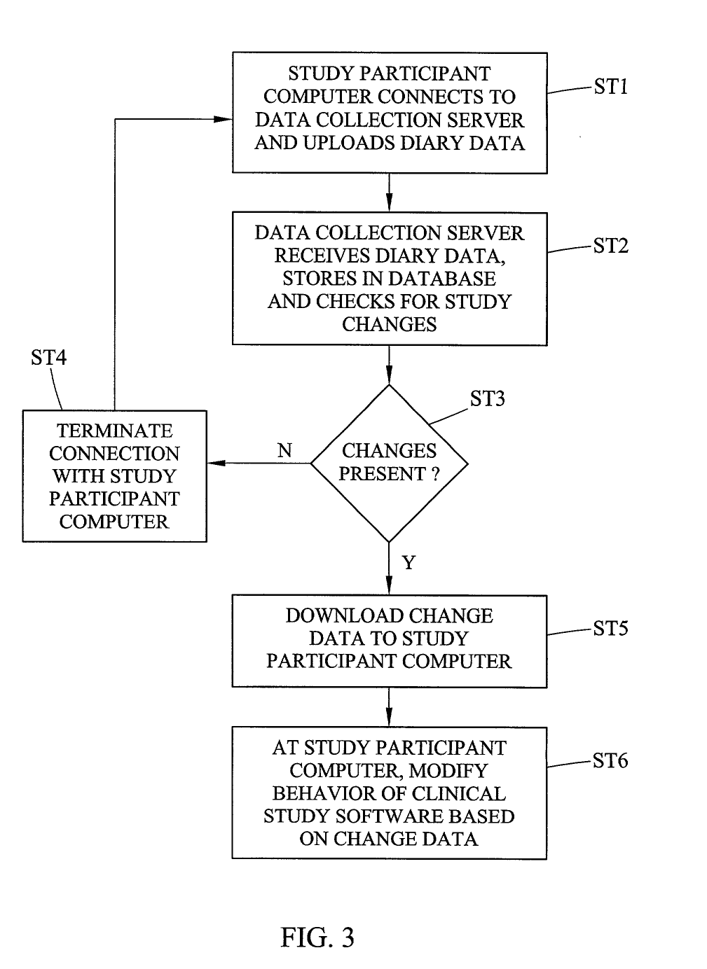

FIG. 3 is an overall block diagram illustrating exemplary steps performed by software on data collection server 20 and study participant computers 49 for implementing a change to a study in progress. Referring to FIG. 3, in step ST1, a study participant computer 49 connects to data collection server 20 and, once the connection is accepted, uploads diary data. In a preferred embodiment of the invention, the connection is a TCP/IP connection. The diary executor 62 executing on particular a study participant computer 49 includes TCP/IP client software, and collector 54 executing on the data collection server 20 includes TCP/IP server software. Although the TCP/IP functionality of diary executor 62 may be implemented using a convention web browser, in a preferred embodiment of the invention, the client functionality of diary executor 62 is independent from any web browsers that may be executing on any client computer 49.

One reason that independent client functionality is preferred is that in some conventional clinical trials data collection systems, patient surveys are implemented as HTML forms. In order to send a new survey or questionnaire to a study participant computer, it is necessary to send an entire new HTML file for the new form. According to the present invention, patient surveys are implemented using extensible markup language (XML) data stored in the EPD file. Each diary executor 62 can update the questions in a particular survey simply by receiving new XML data from data collection server 20. Updating forms using new data rather than downloading entire forms decreases the time required for changing study questionnaires.

In step ST2, data collection server 20 receives the diary data from study participant computer 49, stores the diary data in diary database 58, and checks for any study changes present in the database for the particular patient computer 49. For example, collector 56 may search diary database 58 using an identifier that identifies the particular study participant computer. The search may result in one or more study change files for the particular patient computer. The study change files may include new EPD and/or DLL files to be downloaded to study participant computer 49. In an alternate embodiment that will be discussed in detail below, the change data may include a new diary executor.

In step ST3, if data collection server 20 determines that changes are not present, control proceeds to step ST4 where data collection server 20 terminates the connection with the patient computer and returns to step ST1 to wait for the next connection. However, if data collection server 20 determines that changes are present, control proceeds to step ST5, where the data collection server 20 downloads the change data to the patient computer. If the change data includes a new EPD file and one or more new DLLs, the new EPD file may contain new data for the forms and the location and names of the new DLLs to be executed by study participant computer 49. In step ST6, study participant computer 49 receives the change data and modifies the behavior of its diary executor 62 based on the change data. For example, if the change data is a new EPD file, diary executor 62 may use the change data to populate forms displayed to the patient. If the change data includes any new DLLs, these DLLs may be executed in place of default code in diary executor 62. An exemplary mechanism for determining whether to execute default code or new DLLs will be described in more detail below.

The steps illustrated in FIG. 3 are preferably performed each time a study participant computer 49 connects to data collection server 20 to upload data. Because a study change can be implemented automatically when study participant computer 49 connects to data collection server 20 to upload data, the need for returning the study participant computers to the data collection site for reprogramming is reduced. In addition, because the operation of software on study participant computers 49 can be altered without requiring a new executable file in this example, the amount of software validation is reduced. For example, if the new functionality can be implemented using a DLL, only the DLL needs to be validated. This further reduces the time required to implement a study change. Because some study changes can be implemented simply by downloading new data in the EPD file to a study participant computer, the time required to update forms over conventional browser-based solutions is reduced.

Another feature or advantage of the methods and systems described herein for implementing a mid-study change is that multiple study participant computers 49 can be automatically updated. For example, an administrator may create and store a global change in diary database 58. When each study participant computer connects to collector 56 to upload its data, the global change is automatically downloaded to each machine. As a result, none of study participant computers 49 need to be returned to the central site, and the time for implementing the global change is greatly reduced over conventional updating methods.

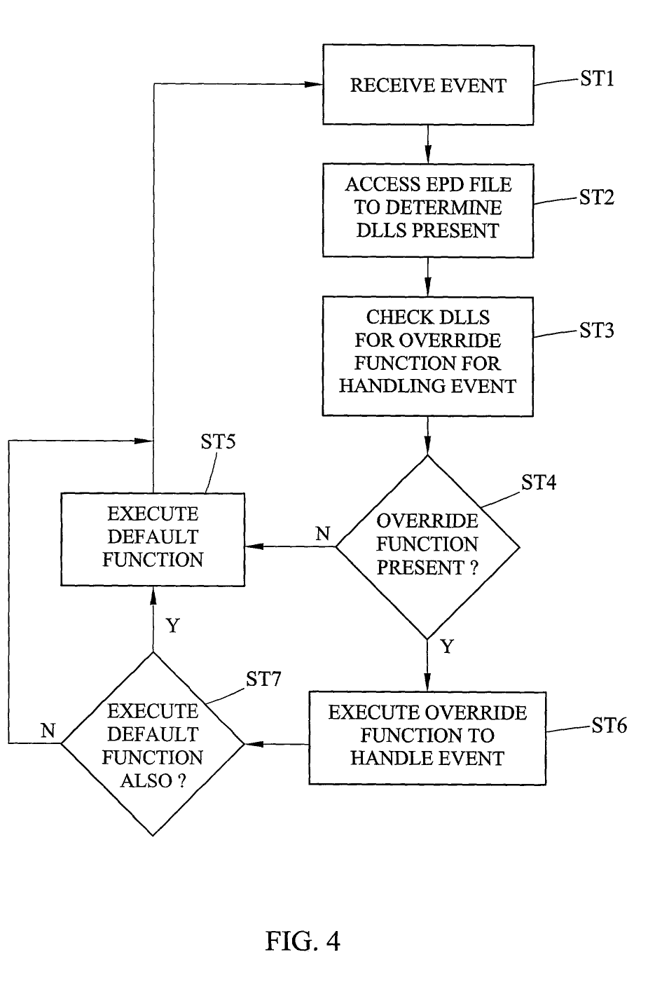

FIG. 4 illustrates exemplary steps performed by a diary executor 62 executing on a study participant computer 49 in determining whether to execute a DLL or default code in response to receiving an event. As used herein, the term “event” refers to an action that occurs during the execution of the diary executor, such as displaying a particular screen to a patient. The patient display event will be used as an example explaining the functionality of the diary executor. Referring to FIG. 4, in step ST1, diary executor 62 receives or detects an event, such as the display of a screen to a patient. In step ST2, the diary executor accesses EPD file 64 to determine whether any DLLs are present for the event. In steps ST3 and ST4, diary executor 62 checks the DLLs for override functions for handling the patient display event. In step ST5, if no override functions are present, diary executor 62 executes the default functions and control proceeds to step ST1 where diary executor 62 receives the next event. If, on the other hand, diary executor 62 determines that an override function is present, control proceeds to step ST6, where diary executor 62 executes the override function in the DLL to handle the event. In certain instances, it may be desirable to execute the default functions as well. Accordingly, in step ST7, diary executor 62 determines whether to execute the default function in addition to the override function. If diary executor 62 determines that it is necessary to execute the default function, control proceeds to step ST5 where the default function is executed. If the default function is not to be executed in addition to the override function, control returns to ST1 where diary executor 62 receives the next event. Thus, using the steps illustrated in FIG. 4, portions of diary executor 62 can be replaced without modifying the actual code of diary executor 62.

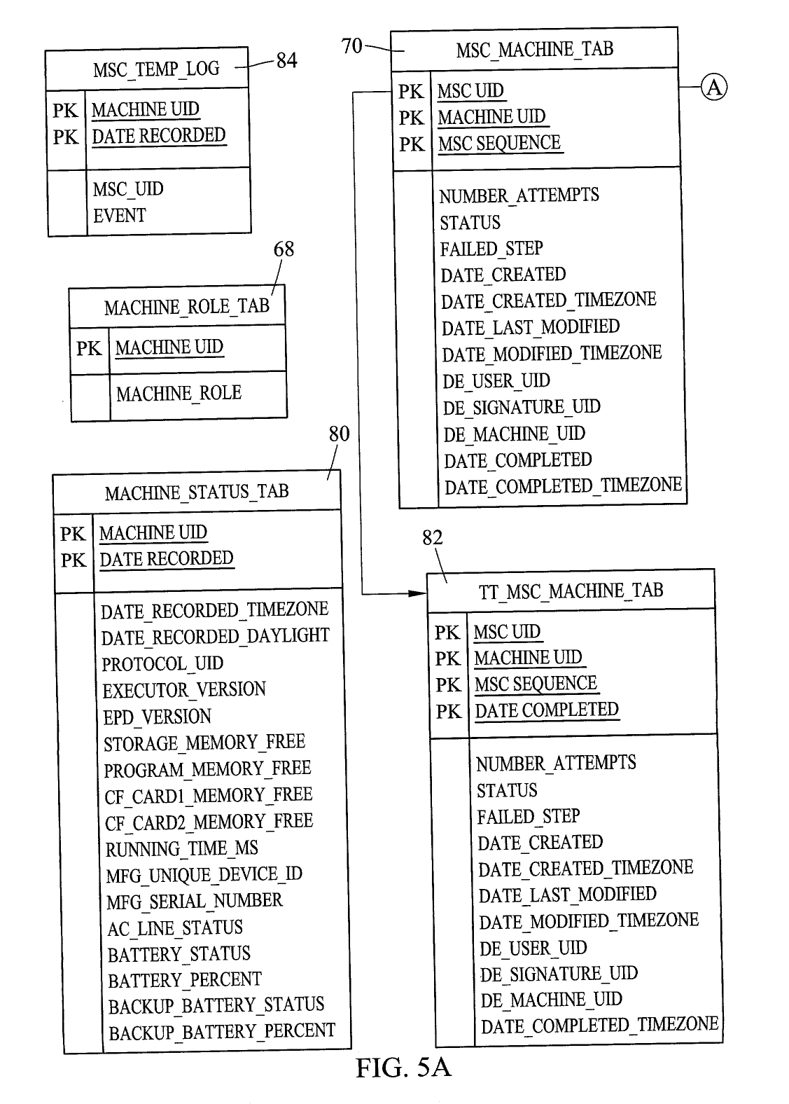

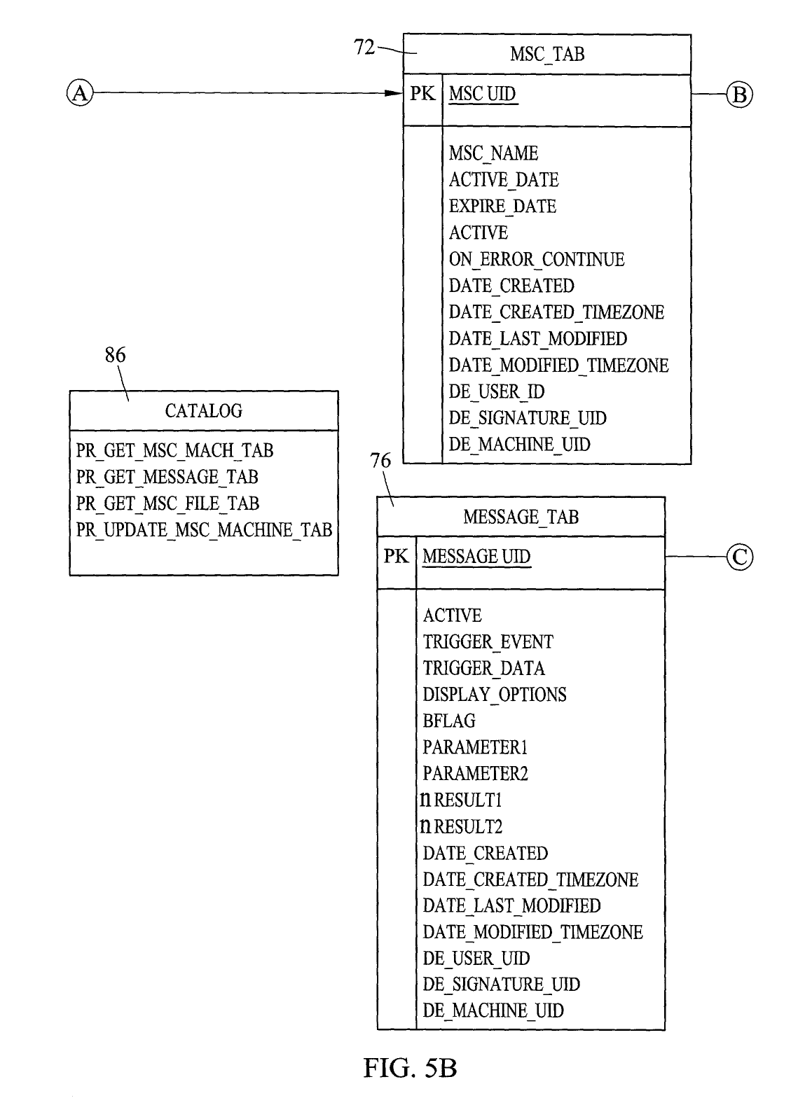

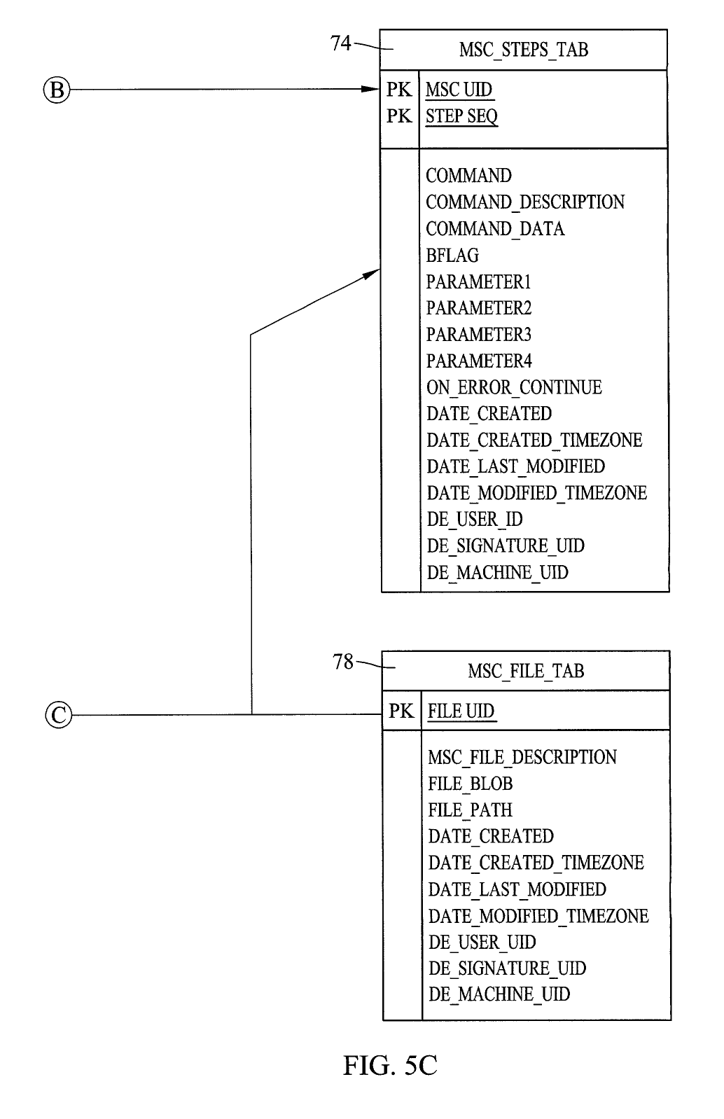

As stated above, in order to determine whether software on a study participant computer 49 needs to be updated, collector 56 acts accesses diary database 58. Diary database 58 may include various data structures that allow collector 56 to determine whether changes have been defined for a given participant computer 49 or a group of participant computers 49 and for actually implementing the change. FIGS. 5A-5C illustrate exemplary data structures that may be included in diary database 58 for implementing changes to clinical studies in progress. Referring to FIGS. 5A-5C, a machine role table 68 stores data for identifying whether a participant computer 49 is associated with a patient or a site. Machine role table 68 is keyed by a machine user id. The machine user id is used to look up the role for the particular machine.

Mid-study change machine table 70 associates or assigns a mid-study change to a machine to be updated. Collector 56 performs a lookup in mid-study change machine table 70 using a machine identifier received from one of participant computers 49. If a change has been defined for the particular study participant computer 49, the lookup in mid-study change table 70 results in a pointer to a record in mid-study change table 72. Mid-study change table 72 stores a mid-study change identifier for identifying a study change to be implemented on the particular machine. The record in mid-study change table 72 contains a pointer to a record in mid-study change steps table 74. Mid-study change steps table 74 stores a list of specific steps to be performed for a given mid-study change.

As will be described in more detail below, implementing a change on a patient participant computer includes sending a sequence of commands from collector 56 to the participant computer 49 on which the change is being implemented. Mid-study change steps table 74 stores a sequence of such commands for implementing the change. Each command may include one or more parameters or messages. Accordingly, message table 76 stores messages to be sent to a particular study participant computer 49. In addition to messages, a command sent to a particular study participant computer 49 may include one or more computer files, such as DLLs, new executables, or new EPD files. Mid-study change file table 78 stores files to be sent to a study participant computer 49.

Additional tables that may be included in diary database 58 for implementing mid-study changes include a machine status table 80, a mid-study change audit table 82, and a mid-study change log table 84. Machine status table 80 stores the current state of a particular machine. The state information stored in machine status table 80 may include the version of diary executor 62 executing on a machine, the amount of free memory space, battery status, etc. Mid-study change machine audit table 82 stores an audit trail for a mid-study change applied to a particular machine. For example, audit table 82 may store the number of attempts that a mid-study change was attempted to be downloaded to a particular machine, the step at which a particular change failed, the date of completion of a mid-study change, etc. Mid-study change log table 84 stores when a mid-study changed is re queued for a particular machine.

In order to extract data from the tables illustrated in FIGS. 5A-5C, diary database 58 may include a group of stored procedures related to a mid-study change. A stored procedure is a piece of code consisting of declarative and procedural structured query language (SQL) statements stored in the catalog of a database that can be activated by calling it from a program, a trigger, or another stored procedure. According to the present invention, collector 56 may call one or more stored procedures in diary database 58 to implement a mid-study change.

In FIG. 5B, a catalog 86 includes stored procedures associated with a mid-study change. In the illustrated example, the stored procedures include a get mid-study change machine table procedure, a get message table procedure, a get mid-study change file table procedure, and an update mid-study change machine table procedure. Collector 56 calls get mid-study change machine table to return a list of steps for a given mid-study change. Collector 56 calls the get message table procedure when the collector finds a message step in the steps associated with the mid-study change. The get message table procedure returns the message specific data to the collector. Collector 56 executes get mid-study change file table when collector 56 finds a file/download step in a given mid-study change. The get mid-study change file procedure 56 returns a specific file path to collector 56. Collector 56 uses the file path to extract the file from the file system of data collection server 20. Collector 56 runs update mid-study change machine table procedure to return the success or failure of a mid-study change to mid-study change machine table 70. The update mid-study change machine table procedure stores all updates in mid-study change machine audit table 82. The update mid-study change machine procedure removes successfully implemented mid-study changes from mid-study change machine table 72.

As stated above, collector 56 preferably sends a sequence of commands to a study participant computer 49 in order to implement a mid-study change. Table 1 shown below illustrates exemplary commands that may be sent from collector 56 to a particular study participant computer 49 in order to implement a mid-study change.

TABLE 1
Mid-study Change Commands

| Command | Data | bFlag | Parameter1 | Parameter2 | nResult1 | nResult2 |
|---|---|---|---|---|---|---|
| ‘T’ TERMINATE | | 0 | NULL | NULL | 0 | 0 |
| ‘W’ WHOAREYOU | | 0 | NULL | NULL | 0 | 0 |
| ‘D’ DELETE | | 0 | Client full | NULL | 0 | 0 |
| | | | path & name | | | |
| ‘O’ | | 0 | Client full | NULL | 0 | 0 |
| REMOVEDIRECTORY | | | path | | | |
| ‘R’ RECEIVEFILE | UID | 0 | Client full | NULL | 0 | 0 |
| | | | path & name | | | |
| ‘S’ SENDFLLE | path | 0 | NULL for trn | NULL | 0 | 0 |
| | | | \| Client full | | | |
| | | | path | | | |
| ‘X’ EXECUTESCRIPT | | 0 | Client full | NULL | 0 | 0 |
| | | | path & name | | | |
| ‘Y’ | | 0 | Client full | NULL | 0 | 0 |
| CREATEDIRECTORY | | | path (no | | | |
| | | | trailing ‘\’) | | | |
| ‘I’ | | 1 | NULL | ResetApp, | 0 | 0 |
| EXECUTEINTERNAL | | | | ExitApp, | | |
| | | | | ResetDevice or | | |
| | | | | DialAtNextStartup | | |
| ‘C’ SETCLOCK | | 1\|2* | NULL | stGMT = GMT | 0 | 0 |
| | | | | datetime | | |
| ‘E’ EXECUTEFILE | | 1 | Client full | Exe's parameters | 0 | 0 |
| | | | path & name | | | |
| ‘M’ MOVEFILE | | 1 | Client source | Client dest full | 0 | 0 |
| | | | full path & | path & name | | |
| | | | name | | | |
| ‘K’ COPYFILE | | 1 | Client source | Client dest full | 0*\|1 = existFail | 0 |
| | | | full path & | path & name | | |
| | | | name | | | |
| ‘B’ STUDYSTART | | 0 | NULL | NULL | m_dwUID | 0 |
| ‘P’ SETENCRYPTION | | 0 | NULL | NULL | O = off; 1 = On | 0 |
| ‘Q’ STUDYEND | | 0 | NULL | NULL | m_dwUID | 0 |
| ‘V’ SETVARIABLE | | 0\|1\|2\|3 | Name of | String to Set \| | Long to set | 0 |
| | | | Variable | Time to set | | |
| ‘N’ RECEIVEMESSAGE | UID | 1\|2*\|3 | Message text | fromString \| | 0 \| dwUID (1) | [date] |
| | | | | datetime | | |
| ‘0’ SubjectArchive (2) | | 0 | Name for | NULL | 0 | 0 |
| | | | Archive | | | |
| ‘1’ UserArchvie (2) | | 0 | Name for | NULL | 0 | 0 |
| | | | Archive | | | |
| (‘G’ SENDMESSAGE) | | | | | | |
| (‘P’ Purge Storage) | | | GMT date | (Client full path) | | |
| (‘Z’ Delete Message) | | | Message_UID | NULL | | |

In Table 1, the first column indicates the various commands used by collector 56 to implement a mid-study change. The data column stores data that may be included in the command. The bFlag column stores flags associated with the command. The parameter columns store parameters for each command. Finally, the results column stores results of a particular command that may be sent back to collector 56. The commands will now be explained in the order they appear in Table 1.

The TERMINATE command is sent from collector 56 to a diary executor 62 in order to indicate to diary executor 62 that a connection with data collection server 20 will be terminated. After sending the terminate command, data collection server 20 may terminate a TCP/IP connection with the particular study participant computer 49.

The WHO ARE YOU command is sent from collector 56 to a diary executor 62 to request that diary executor 62 provide the machine ID of the study participant computer 49 on which the diary executor 62 is executing.

The DELETE command is sent from collector 56 to a diary executor 62 to request that the diary executor 62 delete a file. This command may be used to delete files being replaced by a mid-study change.

The REMOVE DIRECTORY command is sent from collector 56 to a diary executor 62 to request that diary executor 62 delete a directory in the file system of a study participant computer 49. The delete directory transaction may be used to remove a file directory containing one or more files that may be replaced during a mid-study change.

The RECEIVE FILE command is sent from collector 56 to a diary executor 62 in order to request that diary executor 62 receive a file. This command may be sent in order to download files to a study participant computer 49, such as new DLLs, executable files, or data files.

The SEND FILE command may be sent from collector 56 to a diary executor 62 to request that diary executor 62 send a particular file to collector 56. This command may be used to collect data entered by a study participant or to obtain a copy of a file resident on study participant computer 49.

The EXECUTE SCRIPT command is sent from collector 56 to a diary executor 62 to request that diary executor 62 execute a script file. A script file may be used to display data to a study participant or to implement a mid-study change.

The CREATE DIRECTORY command may be sent from collector 56 to a diary executor 62 to request that diary executor 62 create a file directory in the file system of a particular study participant computer 49. Creating a new file directory may be useful in implementing a mid-study change when a DLL references code located in a new file directory.

The EXECUTE INTERNAL command is sent from collector 56 to a diary executor 62 to request that diary executor 62 execute an internal command. Examples of internal commands include reset application, exit application, reset device, or dial at next startup. These commands may be used to control the execution of programs associated with a mid-study change.

The SET CLOCK command may be sent from collector 56 to a diary executor 62 to synchronize the clock on a particular patient computer 49 with a master clock managed by collector 56.

The EXECUTE FILE command may be sent from collector 56 to a diary executor 62 to execute a particular file. For a mid-study change, the file may include a new version of diary executor 62.

The MOVE FILE command may be sent from collector 56 to a diary executor 62 to request that diary executor 62 move a file to a new location. This transaction may be used to replace one or more files associated with a mid-study change without deleting the original files. For example, in order to replace diary executor 62, collector 56 may first send a move file command to diary executor 62. In response to the move file command, diary executor 62 may copy itself to a new directory. Collector 56 may then send a receive file command containing the new version of the diary executor. Diary executor 62 receives the new file and stores it in the previous location of diary executor 62.

The COPY FILE command may be sent from collector 56 to a diary executor 62 to copy a file from one location in the file system of a study participant computer 49 to another location. The COPY FILE command is used in the same manner as the MOVE FILE command except that the original file remains in its original location.

The STUDY START command is sent from collector 56 to diary executor 62 to initiate a clinical study. For mid-study change purposes, the study start command may be sent to restart a clinical study after one or more files associated with the study have been changed.

The SET ENCRYPTION command may be sent from collector 56 to a diary executor 62 to activate or deactivate encryption for communications between collector 56 and diary executor 62. For example, because communications from a particular diary executor may include confidential patient data, encryption is preferably used to transmit this data over IP network 60 because IP network 60 may be a public IP network. However, such encryption may not be required when transferring files from collector 56 to a diary executor 62 associated with a mid-study change. Accordingly, the SET ENCRYPTION command may be used to activate and deactivate encrypted communications, as appropriate.

The STUDY END command may be sent from collector 56 to a diary executor 62 to instruct diary executor 62 to post a study end message for the specified study participant. In response to receiving the study end message, diary executor 62 may display a study end message on the screen of study participant computer 49 to indicate that a particular study has ended.

The SET VARIABLE command may be sent from collector 56 to a diary executor 62 to change the value of a particular variable associated with a study. In response to receiving the SET VARIABLE command, diary executor 62 may overwrite one or more variables in EPD file 64.

The RECEIVE MESSAGE command is sent from collector 56 to a diary executor 62 to request that the diary executor 62 display a particular message to study participant. In response to the received message command, diary executor 62 may display the contents of the message to the study participant on the screen of study participant computer 49.

The SEND USER/SUBJECT ARCHIVE commands may be sent from collector 56 to a diary executor 62 to request that the diary executor 62 receive user or subject archives, depending on the particular command. The user or subject archives may store user or subject responses to questions in a clinical study stored on a study participant computer 49.

The SEND MESSAGE command may be sent by collector 56 to a diary executor 62 to request that the diary executor 62 send a particular message to collector 56.

The PURGE STORAGE command may be sent by collector 56 to a diary executor 62 to request that the diary executor 62 erase memory space on a particular study participant computer 49. The purge storage command may be sent after all data with regard to a particular study has been collected from the study participant computer 49 so that the study participant computer 49 can be used by another study participant.

The DELETE MESSAGE command is sent from collector 56 to a diary executor 62 to request that diary executor 62 delete a particular message from the screen of a study participant computer 49. This command may be sent after the administrator has determined that a message has been displayed long enough on the screen of participant computer 49 to be observed by the study participant.

Thus, as described with regard to Table 1, the present invention includes a comprehensive command set and a protocol between collector 56 and diary executor 62 in order to remotely perform a mid-study change without requiring that study participant computers 49 be returned to a central location and reprogrammed. As a result, the present invention reduces the time required to perform and collect data in clinical studies.

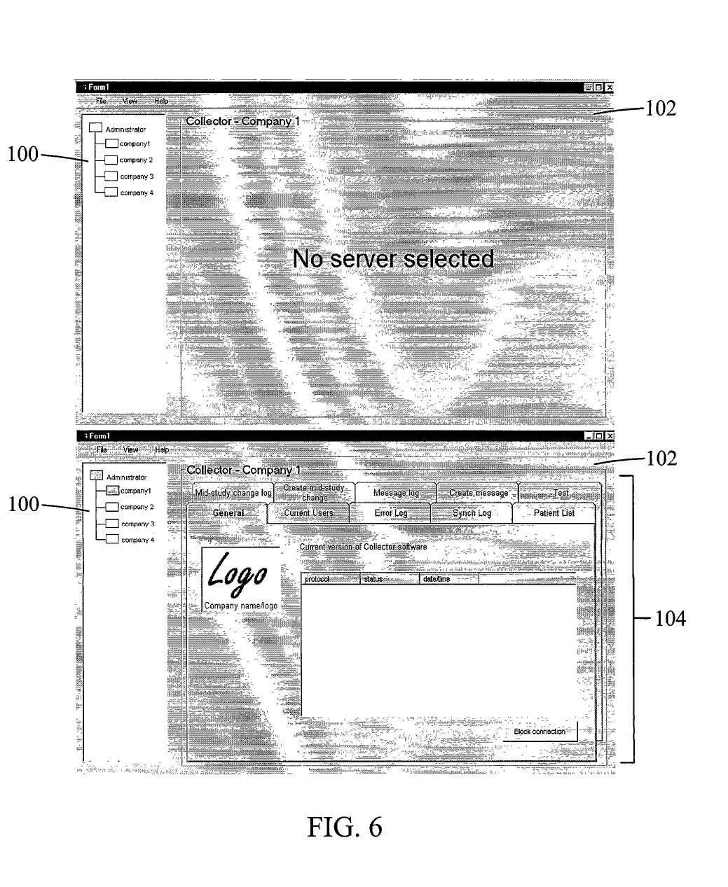

As stated above, data collection server 56 includes a study editor 54 that allows an administrator to administer clinical studies and define and manage mid-study changes. Study editor 54 may be implemented as a folder-oriented graphical user interface that allows users to define various aspects of mid-study changes. FIG. 6 is a computer screen shot of two screens that may be associated with study editor 54. In particular, the upper portion of FIG. 6 illustrates a file tree 100 that an administrator may use to manage collector software 56 and mid-study changes for multiple companies. In the upper portion of FIG. 6, none of the file tabs are selected. Accordingly, the display portion 102 of the screen shot indicates “No server selected.” In the lower portion of FIG. 6, the directory tree for company 1 is selected in file tree 100. Accordingly, display portion 102 of the screen shot displays company specific information. In this example, the company specific information includes a set of folder tabs 104 associated with a mid-study change. In the illustrated example, the general folder is selected. The general folder displays the current version of the collector software running for a particular company.

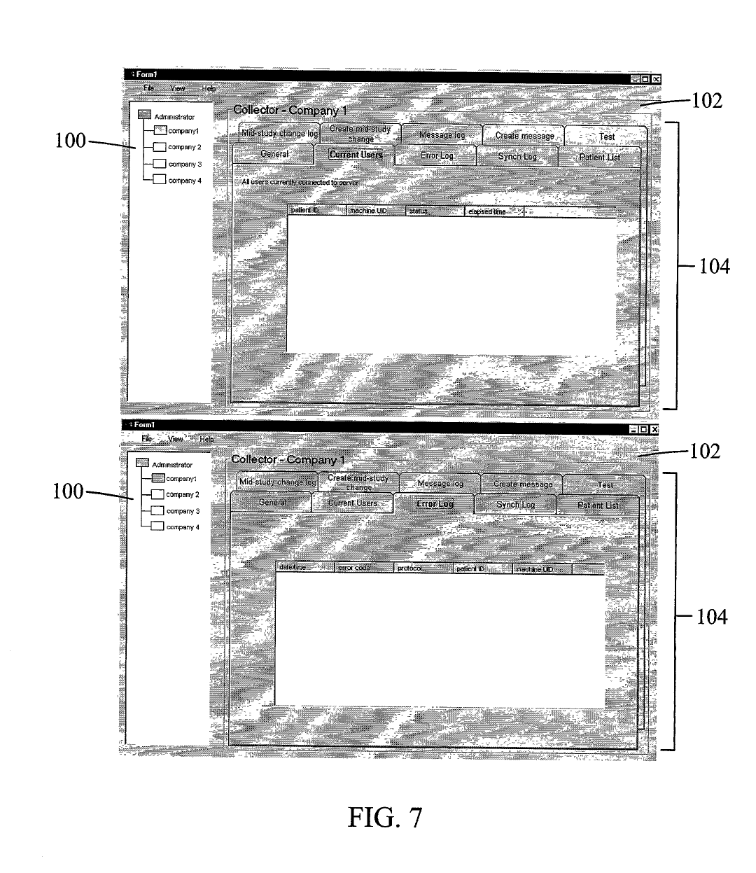

FIG. 7 illustrates the current user and the error log folders of folder tabs 104. The current user's folder lists the users associated with a particular clinical study. Each user is identified by a patient ID, a machine ID, and the elapsed time since the beginning of the study.

In the lower portion of FIG. 7, the error log folder stores errors associated with study participant computers 49. For each error, the error log folder stores the date and time, an error code, a protocol version, a patient ID, and a machine ID associated with each error.

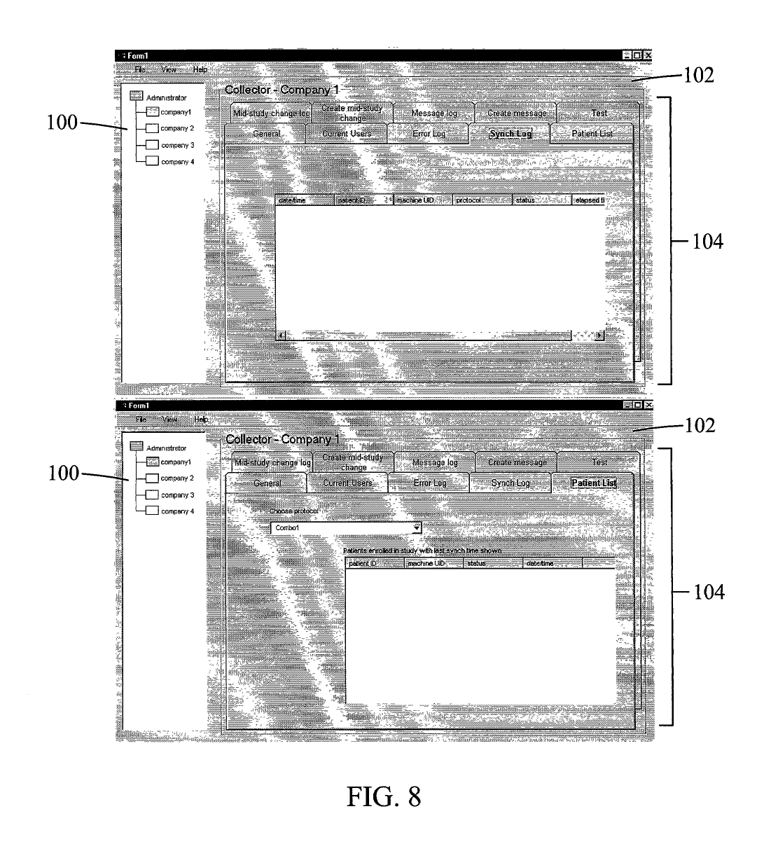

FIG. 8 illustrates the sync log and patient list folders associated with folder tabs 104. The sync log folder stores information associated with file uploads performed by each study participant computer 49. In particular, the sync log folder may store the date, time, patient ID, machine ID, protocol, status, and elapsed time associated with data uploads from each study participant computer. The patient list folder stores information associated with study participants are patients stored in each study. In the illustrated example, the patient list folder stores the patient ID, machine ID, status, and date and time since last sync for each patient.

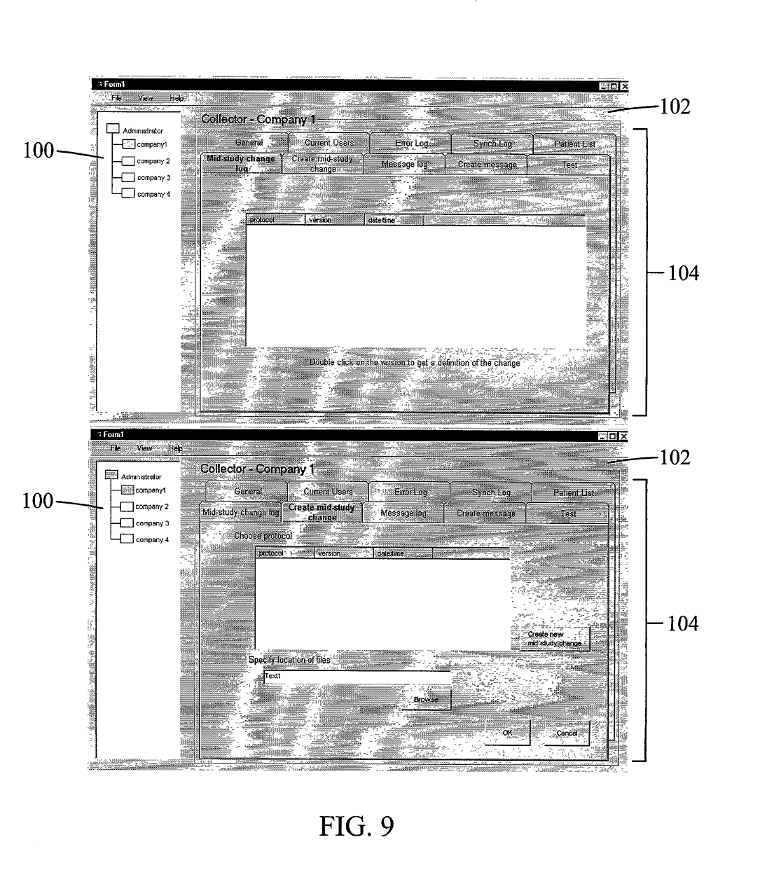

FIG. 9 illustrates the mid-study change log and create mid-study change folders associated with folder tabs 104. The mid-study change log folder stores the protocol, version, and date and time associated with each mid-study change stored in diary database 58. The create mid-study change folder allows an administrator to define a new mid-study change.

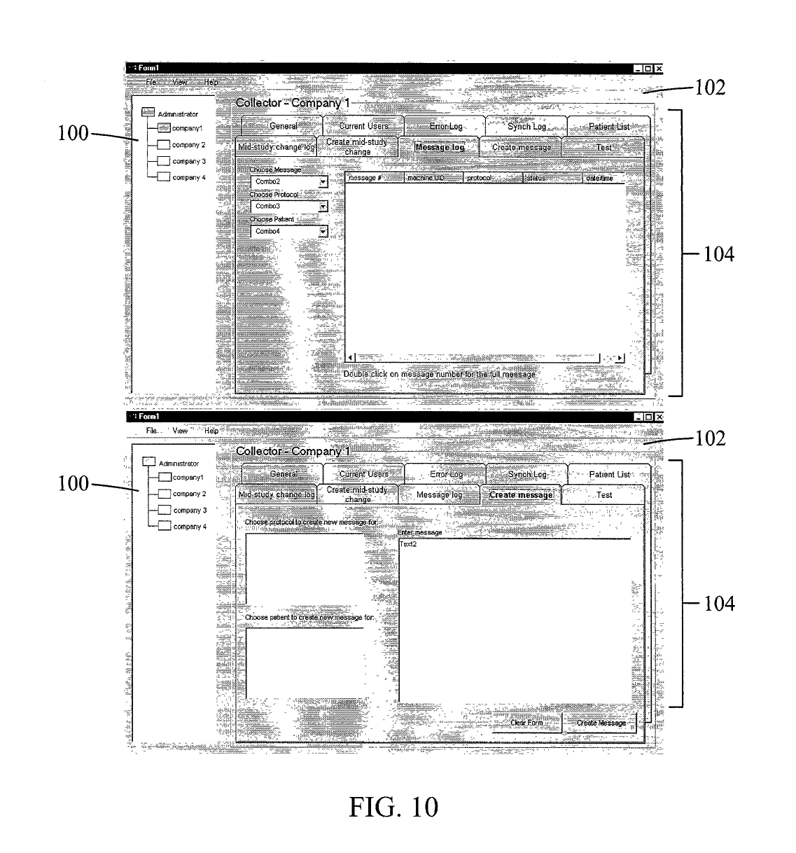

FIG. 10 illustrates the message log and create message folders associated with folder tabs 104. The message log folder stores information associated with messages sent to study participant computers 49. The messages are identified by message number, machine user ID, protocol, status, and time that the messages were sent. The create message folder allow the administrator to define text to be included in the message to be sent to a study participant computer 49.

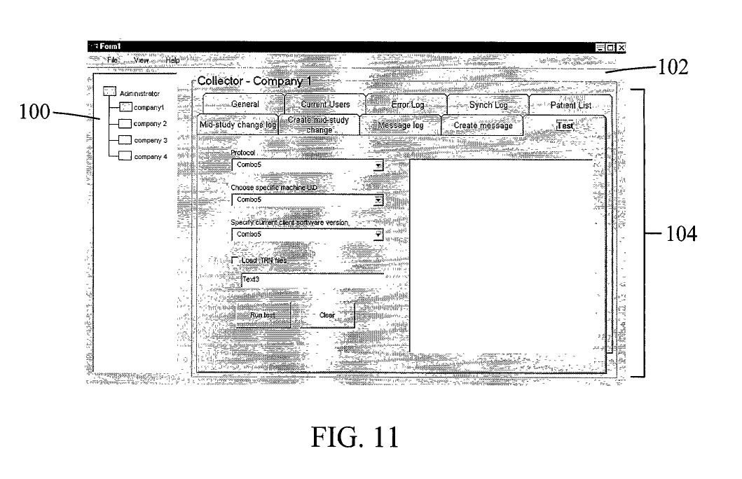

FIG. 11 illustrates the test folder associated with folder tabs 104. The test folder allows the administrator select one or more tests to be downloaded and executed by a study participant computer 49.

Thus, by providing a graphical user interface with a series of easy to use folders, study editor 54 further reduces the time required to design and implement a mid-study change.

It will be understood that various details of the invention may be changed without departing from the scope of the invention. Furthermore, the foregoing description is for the purpose of illustration only, and not for the purpose of limitation—the invention being defined by the claims.

What is claimed is:

1. A method for automatically changing a clinical study in progress, the method comprising:
(a) at a data collection server, receiving patient diary data from patient diary software executing a plurality of remotely located study participant computers;
(b) in response to receiving patent diary data from one of the study participant computers, storing the diary data in a diary database and determining whether study changes have been defined in the diary database for the patient diary software executing on the study participant computer;
(c) in response to determining that a change has been defined for the patient diary software executing on the study participant computer, extracting change data from the diary database and downloading the change data to the study participant computer; and
(d) at the study participant computer, receiving the change data and altering execution of the patient diary software based on the change data.

2. The method of claim 1 wherein receiving patient diary data from study participant diary software executing on a plurality of remotely located patient computers comprises:
(a) periodically establishing TCP/IP connections with each of the study participant computers; and
(b) receiving the patient diary data via the TCP/IP connections.

3. The method of claim 1 wherein determining whether any study changes have been defined in the diary database for the patient diary software executing on the study participant computer includes performing a lookup in the patient diary database using an identifier corresponding to the study participant computer.

4. The method of claim 1 wherein extracting change data from the diary database includes extracting a dynamic link library from the diary database and wherein downloading the change data to the study participant computer comprises downloading the dynamic link library to the study participant computer.

5. The method of claim 1 wherein extracting change data from the diary database includes extracting clinical study form data from the diary database and downloading the clinical study form data to the study participant computer.

6. The method of claim 1 wherein extracting change data from the diary database includes extracting a dynamic link library and clinical study form data from the diary database wherein downloading the change data to the patient computer comprises downloading the form data and the dynamic link library to the study participant computer.

7. The method of claim 4 wherein altering execution of the patient diary software includes executing a function in the dynamic link library in place of a function in the patient diary software.

8. The method of claim 4 wherein altering execution of the patient diary software includes executing a function in the dynamic link library and a default function in the patient diary software.

9. The method of claim 5 wherein altering execution of the patient diary software includes displaying a new form to the patient using the form data received from the data collection server.

10. A system for implementing a change to a clinical study in progress, the system comprising:
(a) a plurality of study participant computers for collecting patient diary information from study participants;
(b) a collector operatively associated with the study participant computers for receiving the patient diary information from the study participant computers and for automatically changing software executing on the study participant computers; and
(c) a diary database operatively associated with the collector for receiving and storing the patient diary information and for storing change data for changing the software executing on the study participant computers.

11. The system of claim 10 wherein the study participant computers comprise handheld computers.

12. The system of claim 10 wherein the collector comprises software resident on a data collection server remotely located from the study participant computers.

13. The system of claim 10 wherein the collector is adapted to search the diary database using an identifier of a study participant computer to determine whether any change data is present for the study participant computer.

14. The system of claim 13 wherein the collector is adapted to search the diary database for change data corresponding to a particular study participant computer in response to receiving diary data from the study participant computer.

15. The system of claim 10 wherein the collector is adapted to send commands to the study participant computers to automatically change the operation of the software resident on the study participant computers.

16. The system of claim 10 wherein the collector is adapted to download dynamic link libraries to the study participant computers to alter the operation of the software executing on the study participant computers.

17. The system of claim 10 wherein the collector is adapted to download patient diary form data to the study participant computers to alter the operation of the software executing on the study participant computers.

18. The system of claim 10 wherein the collector is adapted to download an executable file to the study participant computers to alter the operation of the software executing on the study participant computers.

19. The system of claim 10 wherein the diary database is resident in memory on a computer accessible by the collector.

20. The system of claim 10 comprising a study editor operatively associated with the diary database for defining and altering the change data.

21. The system of claim 10 wherein the diary database includes a plurality of tables for storing and tracking changes to clinical studies in progress,

22. A computer program product comprising computer executable instructions embodied in a computer-readable medium for performing steps comprising:
(a) receiving patient diary data from a study participant computer;
(b) in response to receiving the patient diary data from the study participant computer, determining whether any study changes have been defined for the study participant computer; and
(c) in response to determining that a study change has been defined for the study participant computer, automatically downloading the study change to the study participant computer.

23. The computer program product of claim 22 wherein receiving patient diary data includes receiving patient diary data over a TCP/IP connection with the study participant computer.

24. The computer program product of claim 22 wherein determining whether any study changes have been defined for the study participant computer includes searching a diary database using an identifier corresponding to the study participant computer.

25. The computer program product of claim 22 wherein automatically downloading the study change to the study participant computer includes downloading a dynamic link library to the study participant computer.

26. The computer program product of claim 22 wherein automatically downloading the study change to the study participant computer includes downloading an executable file to the study participant computer.

27. The computer program product of claim 22 wherein automatically downloading the study change to the study participant computer includes downloading patient diary form data to the study participant computer.

28. The computer program product of claim 22 comprising sending commands to the study participant computer for instructing the study participant computer as to how to implement the study change.

29. The computer program product of claim 22 wherein sending commands includes sending a sequence of commands for instructing the study participant computer to store and execute one or more computer files associated with the study change.

30. A computer program product comprising computer-executable instructions embodied in a computer readable medium for performing steps comprising:
(a) receiving clinical study change data at a participant computer;
(b) executing software for collecting patient diary data from a study participant;
(c) detecting an event associated with the data collection;
(d) in response to the event, determining whether the change data includes an override function for handling the event; and
(e) in response to detecting that the override function is present, executing the override function in place of a default function for handling the event.
